(19) United States
(12) Patent Application Publication
(10) Pub. No.: US 2006/0290562 A1
(43) Pub. Date: Dec. 28, 2006

(54) MARITIME CONTACT MANAGEMENT AND COLLISON AVOIDANCE SYSTEMS AND METHODS

(75) Inventor: Kenneth L. Ehresman, Ramona, CA (US)

Correspondence Address: MCNEES, WALLACE & NURICK LLC, 100 PINE STREET, P.O. BOX 1166, HARRISBURG, PA, 17108-1166, US

(73) Assignee: Ehresoft Technologies, Ramona, CA (US)

(21) Appl. No.: 11/381,936

(22) Filed: May 5, 2006

Related U.S. Application Data
(60) Provisional application No. 60/677,957, filed on May 5, 2005.

(51) Int. Cl. G01S 13/93; G08G 1/16

(52) U.S. Cl. 342/41; 342/179; 701/301

(57) ABSTRACT

Maritime contact management system and methods are provided which, when integrated with a ship's navigational RADAR and Global Positioning System, accurately and dynamically calculates ownship course and speed, tracks contacts, and maintains an active and historical database while algorithmically calculating and digitally displaying multiple contacts to include at a minimum, the contacts' track number, name, identification, class type, courses, speeds, target angles, closest points of approach, and geopositional data to include all relevant latitudes and longitudes. As a collision avoidance system it uses methods to calculate ownship required courses and speeds as well as time to arrive at the user-selected points in order to either open or close a contact as well as calculates true wind direction and speed as well as desired relative wind direction and speed envelopes in support of flight operations. Additionally, the system has a training mode for to support graphic user interface computer based training and a playback mode for historical reconstruction of ownship and contact maneuvering.

### FIELD OF THE INVENTION

The present invention relates to maritime contact management systems, and particularly to contact tracking and collision avoidance systems and methods.

### BACKGROUND OF THE INVENTION

The U.S. Navy and other maritime navigators base the majority of contact management decisions around a time and manning intensive manual, paper-based maneuvering board process. The use of such maneuvering boards is a perishable skill that has a steep learning curve. In order to overcome inherent human error, it is not uncommon to have up to four people simultaneously involved in solving just one maneuvering problem. Additional manning requirements are involved on many ships in order to accurately convey the information to the Officer of the Deck (OOD) and/or the Commanding Officer/Master. When given situations where there exist multiple contacts, the current systems and methods are quickly overwhelmed and may not provide the ship's Commanding Officer/Master and other OODs a complete and accurate picture in a timely manner.

Prior to manual maneuvering boards, mariners relied upon the seaman's eye and the knowledge gained from many hours of standing watches on the bridge. This knowledge pool helped the ship driver make the right decision when confronted with other vessels. The evolution of RADAR allowed vessels to see contacts at great distances and measure the bearing and ranges of those contacts. The manual maneuvering board quickly followed the development of RADAR, and provided ship drivers an alternate visual representation of RADAR contacts based upon trigonometric fundamentals. The use of such maneuvering boards gave OODs and Commanding Officers a better way to frame the problems of navigation and collision avoidance in more concrete terms. While such manual maneuvering boards are helpful, they remain labor intensive, cumbersome, and prone to human error.

Traditional paper-based maneuvering boards are done with a pencil and straightedge. This process can be inaccurate and is often prone to human error. Even the most capable veteran sailor can make mistakes when calculating a maneuvering board solution, especially in time critical situations, periods of rough seas, nighttime operations, or situations where multiple contacts exist. Because of paper-based precision restrictions, a good maneuvering board solution normally takes two to three good RADAR contact hits at an interval of 3 minutes per hit. This nine minutes can be critical to the decision-maker and the difference between a collision at-sea and a safe return to port.

Two additional serious limitations with paper-based maneuvering boards relate to the relative motion-based process that they use. The first serious limitation is that due to the relative ownship motion inherent in all paper-based maneuvering boards, all contact information needs to be recomputed every time ownship maneuvers. If the maneuvering board user misses a change in either ownship course or speed, all subsequent contact course, speed, CPA and target angle calculations will no longer be valid. The second limitation is that due to human measurement error, a contact that has a constant bearing and decreasing range (CBDR) with a high probability of collision may appear to be changing course with every different measurement. Even experienced OOD's can miss the subtleties and be lulled into complacency, either resulting in collision or unnecessary close miss.

The OOD decision-making process used by modern mariners is designed to try and reduce uncertainty by gathering information, and transforming this information into knowledge and understanding. The utilization of RADARs and maneuvering boards aids a Commanding Officer/OOD in reducing the level of uncertainty. One such OOD decision process is known as the OODA Loop: Observation, Orientation, Decision, and Action, as further detailed herein and as represented graphically in FIG. 1.

Observation—The Officer observes the environment (using all sensors, information systems, and situational reports from his subordinates) to collect data about their surroundings and the status of contacts. This data may be correlated, fused, and displayed in a common tactical picture—a representation or image of the contact space. A Commanding Officer or OOD has several methods of retrieving relevant observation data, such as via visual lookouts, surface RADARs, sonar, and/or his/her own eyes.

Orientation—A Commanding Officer/OOD orients himself to the environment—that is, he forms a mental picture of the situation—by converting observation and other into estimates, assumptions, and judgments about what is happening. From this orientation a Commanding Officer/OOD derives his understanding of the contact space, which understanding is also known as situational awareness.

Decision—Based on the understanding derived from his/her Orientation and resulting situational awareness, the Commanding Officer/OOD then decides on a course of action and comes up with a plan.

Action—The Commanding Officer/OOD sets forth his intended action plan and issues orders to put that plan into action.

Whenever trying to establish command and control of a navigational environment, there exists two fundamental factors that shape the environment and decisions to be made: uncertainty and time. For example, since 1996, there has been a marked increase in the number of collisions at sea, resulting in the loss of millions of dollars and thousands of operational hours for ships that are critical to the Navy's force structure. A U.S. Navy investigation into the collision of USS Denver (LPD 9) with USNS Yukon (T-AO 202) found that the Denver Commanding Officer (CO) should have realized his ship was on a collision course with the oiler. In hindsight, had the CO of the Denver had more time to make his critical maneuvering decisions and had he been given more accurate contact information in a more timely manner, the CO of the Denver would never have made such a critical mistake.

There are many variables that play a significant part in the uncertainty and that explain more frequent collisions at sea over the past 5 years. These factors include, among other things, inexperience, inadequate training, crew fatigue, operational tempo, and higher traffic densities on today's seas. The end result is Officers of the Deck and Commanding Officers, Masters, and other ship drivers who may not have complete situational awareness, and as key decision-makers don't receive timely and accurate safety-critical information necessary to make critical navigation decisions. Perhaps a key issue is not the decisions that are made when it comes to maneuvering, rather the accuracy and timeliness of the information available to that the decision-makers prior to making navigation decisions.

Although collisions are a high profile issue, it's the numerous and countless “near misses” that go unreported and often untreated. Looking back into our crystal ball we can see many instances where Commanding Officers/Masters and Officers of the Deck could have benefited from a better system and a better means by which contact information was being displayed and presented to them. The time-tested methods used to make maneuvering decisions are a start—but they clearly require enhancement and improvement to avoid or eliminate navigation errors. The problem is that maneuvering technology has not kept pace with the increase in the ocean's traffic density. What is required is a faster and more accurate system and method by which maneuvering data and calculations are executed and presented, as well as the use of additional data not currently integrated into the known maneuvering board systems ad methods.

### SUMMARY OF THE INVENTION

A system for maritime contact management and collision avoidance, the system comprising at least one microprocessor, a data storage facility accessible by the microprocessor to store, retrieve, and modify received data, at least one graphic user interface associated with the microprocessor, and computer-readable and executable instructions executable by the microprocessor. The instructions execute the steps of: receiving data related to at least one ownship location, course and speed; receiving initial contact data from at least one contact identification source; receiving and processing additional ownship data relating to location, course, or speed; receiving updated contact data from at least one contact identification source; processing the received ownship data and contact data to calculate at least one of the at least one contact's course, speed, target angle, and closest point of approach relative to ownship; and graphically displaying on the graphic user interface data comprising at least one of ownship's course and speed, relative motion between ownship and at least one contact, closest point of approach, and geopositional location.

Dynamic real-time contact management systems and methods are provided which, when integrated with a ship's navigational RADAR and Global Positioning System, accurately and dynamically integrate/calculate ownship course and speed, tracks contacts, maintains an active and historical database, algorithmically calculates and digitally displays multiple contacts and contact information such as, but not limited to the contacts' courses, speeds, target angles, closest point of approach (CPA), the bearing, range and time of CPA, as well as geopositional data to include all relevant latitudes and longitudes. The system of the invention includes a graphical user interface and display that presents contact maneuvering information in a graphically verifiable manner that makes the accuracy of calculations readily apparent to a user skilled in the trade of maritime navigation. The system optionally further includes collision avoidance features such as, but not limited to, generated visual and audible alarms for such items as one or more contacts with calculated closest points of approach within a user-selected distance such as a minimum avoidance distance, and calculates at least one ownship maneuver for collision avoidance of the at least one contact. Optionally, the at least one calculated ownship maneuver may be based on a user's selected preference, such as at least one selected drive to point. Optionally, to further aid in safe navigation, the system of the invention preferably includes two selectable graphical digital display formats—a relative display formatted in Defense Mapping Agency 5090 format, and a true dead reckoning display capable of displaying multiple contacts in their true positions.

### BRIEF DESCRIPTION OF THE FIGURES

FIG. 1 is an illustration of the OODA Loop process.

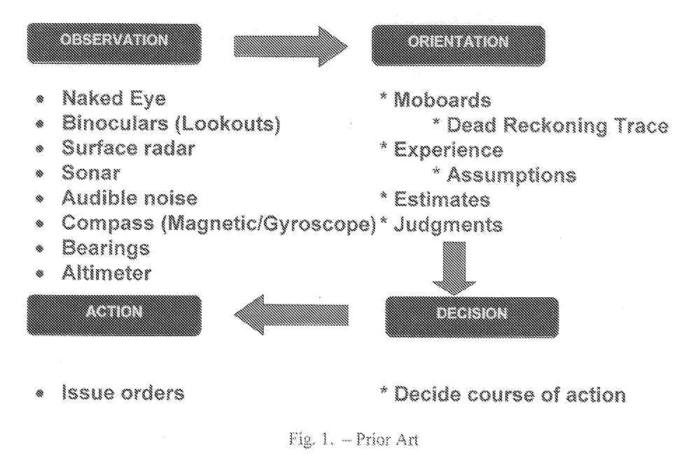

FIG. 2 is a screen shot of a GUI display illustrating ownship course and speed vector in accordance with the present invention.

FIG. 3 is a screen shot of a GUI display illustrating ownship course and speed vector and a contact initial hit in accordance with the present invention.

FIG. 4 is a screen shot of a GUI display illustrating ownship course and speed vector and calculation of a contact course, speed, target angle, and CPA in accordance with the present invention.

FIG. 5 is a screen shot of a GUI display illustrating ownship course and speed vector, and ownship trial course and speed, as well as re-calculated CPAs for two contacts based on ownship trial course and speed in accordance with the present invention.

FIG. 6 is a tabular representation of the data represented in FIG. 5 in accordance with the present invention.

### DETAILED DESCRIPTION

Dynamic real-time contact management systems and methods are provided which, when integrated with a ship's navigational RADAR and Global Positioning System, accurately and dynamically integrate/calculate ownship course and speed, tracks contacts, maintains an active and historical database, algorithmically calculates and digitally displays multiple contacts and contact information such as, but not limited to the contacts' courses, speeds, target angles, closest point of approach (CPA), the bearing, range and time of CPA, as well as geopositional data to include all relevant latitudes and longitudes. The system of the invention includes a graphical user interface and display that presents contact maneuvering information in a graphically verifiable manner that makes the accuracy of calculations readily apparent to a user skilled in the trade of maritime navigation. The system optionally further includes collision avoidance features such as, but not limited to, generated visual and audible alarms for such items as one or more contacts with calculated closest points of approach within a user-selected distance, such as a minimum avoidance distance, and calculates at least one ownship maneuver for collision avoidance of the at least one contact. Optionally, the at least one calculated ownship maneuver may be based on a user's selected preference, such as at least one selected drive to point. Optionally, to further aid in safe navigation, the system of the invention preferably includes two selectable graphical digital display formats—a relative display formatted in Defense Mapping Agency 5090 format, and a true dead reckoning display capable of displaying multiple contacts in their true positions.

In one example, the invention is a networked stand-alone computer hardware and software system that provides timely and accurate contact information for Commanding Officers, OODs, and CIC watch teams. By creating a reliable, automated system in a format that is familiar to all mariners the invention provides decision makers with a valuable tool capable of rapid data exchange while reducing current redundancies and manning inefficient practices. The invention is ready to significantly enhance Safe Navigation at Sea while maintaining the age old, time tested ways of avoiding other vessels under today's reduced manning constraints.

The invention speeds up contact management decisions by eliminating the inherent human error innate to the paper-based maneuvering board process by bringing a high degree of precision with a decrease in hit interval time, thus reducing the overall time required to produce a usable maneuvering board solution. The decrease in solution time in turn decreases the time required to complete the orientation process and thus speeds up the overall decision process. Having more time and more accurate information in an understandable and easy to assimilate presentation is every Commanding Officer's/Master's desire.

Traditional paper-based maneuvering boards are not usable for collision avoidance during ownship maneuvers, as clearly demonstrated by the collision at sea of the USS ARTHUR W. RADFORD (DD 968) with a Saudi Arabian tanker while conducting circular steering off the coast of Hampton Roads, Va. on Feb. 5, 1999. In contrast, the present invention not only overcomes inherent paper-based maneuvering board limitations by calculating contacts' geopositional data based on inputted bearings and ranges, enabling the calculation of contacts' course and speed over ground during ownship maneuvers, but also provides user selectable automated warnings and alerts for contacts of potential collision concern.

Additionally, known paper-based maneuvering board models lie within the Orientation phase of the OODA Loop. In contrast, the present invention provides systems and methods that encompass all four parts of the OODA loop. For example, the present invention includes interaction with digital sources of information such as RADAR and other sensors (Observation), quickly processing the data to reduce the level of uncertainty and the amount of time inherent to the maneuvering board (Orientation), calculating and providing maneuvering recommendations (Decision), and communicating orders between decision makers and crew (Action).

In one embodiment, the invention provides a microprocessor controlled, visually verifiable maritime contact management and collision avoidance system that gathers, processes, and displays navigation information. For example, the invention provides computer readable and executable code (software) that digitally processes gathered information and displays the processed information on a graphic user interface (“GUI”) device. To assist in assimilation of the invention by navigators, the display on the GUI may be similar in appearance to a paper-based maneuvering board. The invention, among other things, can determine a contact's course, speed, CPA, and target angle as well as calculate ownship maneuvering recommendations in the form of course and speed recommendations in order to either increase or reduce all contacts' calculated CPA's.

In a preferred embodiment, the invention pairs the system with the following methods and steps:

Step 1: The system accepts ownship data, such as latitude and longitude, whether by manual operator-input and/or automated GPS inputs. In the event that manual operator inputs are used, the system may also receive GPS inputs and compare the manual inputs to the GPS inputs, and vice versa, and may also alert the operator of any discrepancies there between. Additionally, the system may calculate ownship latitude and longitude based on manual and/or GPS inputs and factor in ownship course and speed on a reselected periodic interval that may be selected and adjusted by an operator.

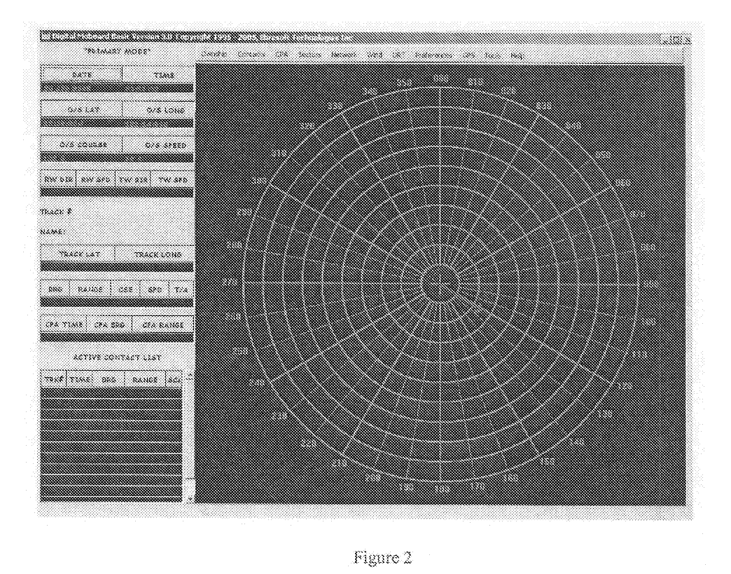

Step 2: The system uses two types of distinct ownship courses and speeds: Course Over Ground (COG) and Speed Over Ground (SOG) as well as course and speed throughout the water. For COG and SOG the system accepts both manual and automated GPS inputs and calculates both COG and SOG as necessary. For course and speed through the water, the system accepts manual operator ownship course and speed inputs and/or uses ownship gyroscope and speed sensor data. The system can optionally receive automated inputs and compare the manual inputs to the automated inputs, and vice versa, and preferably alerts the operator of any discrepancies. Once ownship course and speed are input or calculated, the system draws ownship speed vector, for example as a vector originating from the center of the circular display of FIG. 2.

Step 3: The system receives and processes contact data concerning at least one other contact (i.e. another vessel or any object that is not ownship). Exemplary contact identification sources include, but are not limited to automated sources such as Automatic RADAR Plotting Aid (ARPA) RADARS, non-ARPA RADARs, sonar, beacons, transmissions, automated identification systems (AIS) transceiver devices, data exchange networks, and identification sources that can be manually activated or operated. Exemplary manual contact identification sources include, but are not limited to laser measuring devices, stadimeters, distance measuring binoculars, telescopes, alidades and other manually operated devices, as well as human vision and estimation. The present invention is unique because it can accept contact data from virtually any source, and allows for processing and comparison between data received by different sources relating to a common contact, as well as selection between the various data sources, whether automatically or manually by an operator.

In one example, the system accepts both operator (manual) contact data inputs, as well as contact data from automated sources, whether analog or digital, with the proviso that the system will convert or otherwise process the input data into digital form that is compatible with the computer executable code run by the microprocessor of the system. Based upon the received input contact data, the system calculates at least one contact's longitude and latitude. The system then digitally plots the contact's position on the GUI display relative to ownship, and preserves the received input data and calculated data that includes, among other things, data source, contact identification data, latitude, longitude, bearing and range, and the time associated with the received data relevant to each input, as well as concurrent ownship latitude and longitude.

Step 4: The system continues to gather and process ownship data, as well as updated contact data (i.e. newly received information concerning a previously identified contact, each such updated information hereinafter referred to as a “hit”), updating the course, speed, bearing, and other relevant navigation data relevant to ownship and each contact. For each contact created, the system assigns and generates a track number, contact name, type of contact, true bearing and range, relative bearing and range, and date and time of each received hit or data item. Additionally, the system plots the initial location and subsequent hits of each contact, and continues to monitor each contact as new hits are received. In one example, the system continues to update the display based upon each received hit for that contact, including generating and updating at least one vector associated with that contact, such as the direction of relative motion (DRM), speed of relative motion (SRM), and other known navigation vectors. In one example, the at least one vector may include an actual location and path vector, and a predicted path and location vector for each contact, thereby allowing prediction of a contact's future path and location at any given future time, as well as a comparison of that predicted path and location to ownship's predicted path and location at the same selected future time. FIG. 2 illustrates an exemplary display generated by the present invention following completion of step 2 and 3.

Step 5: The system calculates the latitude and longitude of the contact based on its bearing and range from ownship and displays the calculated latitude and longitude in a Track Latitude and Track Longitude display list. The bearing, range, latitude and longitude are saved to two database locations—a historical database location and an active contact database location. The contact is added to a generated active contact list, preferably with an assigned name (and/or number) and track number displayed therewith. Preferably, the system generates at least one associated list including Track Latitude and Track Longitude for each contact. Preferably, the bearing and range of each contact are also displayed.

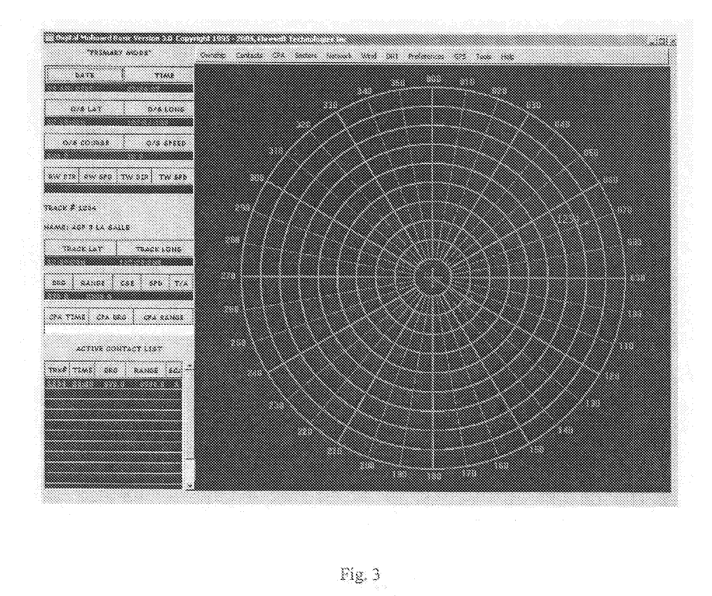

Step 6: The system calculates the maneuvering board display scale to ensure that contacts with significantly different ranges appear on the screen at the same time for each contact hit, and displays the contact on the GUI display, thereby allowing a user to visually confirm the presence of the contact, as well as to view its associated data for accuracy. For example, a user may be comparing the GUI display of a contact with another contact identification source such as a RADAR display screen. Such redundant systems and methods further enhance the accuracy of navigation in accordance with the present invention. FIG. 3 illustrates an exemplary display generated by the present invention upon completion of steps 3 through 6 inclusive.

Step 7: Upon input of a second or subsequent RADAR hit, the system updates the display, by calculating, generating, and displaying the Direction of Relative Motion (DRM) between ownship and each contact. The generation of a Direction of Relative Motion in accordance with the present invention includes the calculation of the Closest Point of Approach (CPA) of the contact by determining the minimum distance that the DRM approaches the ownship location as represented by the center of the GUI displays of FIG. 2-3. In this example, the CPA line is visually displayed for view by a user, and may be associated with an alert or alarm if the CPA is below a user-selected predetermined threshold distance or bearing.

Step 8: The system calculates the distance between the contact's last two RADAR hits, known as Measure of Relative Motion (MRM) as well as the time interval between them. The Invention uses the MRM and the elapsed time between hits to calculate the Speed of Relative Motion (SRM) between ownship and the contact. The SRM is used to and determine the time required for the contact to reach CPA and combined with the DRM is used to calculate the contact's true course and speed. The time required is adjusted for the last contact hit time to determine the time of CPA.

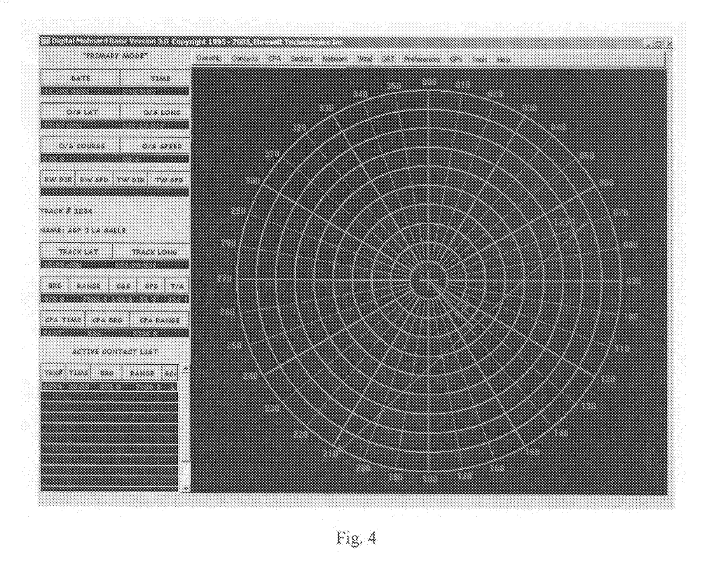

Step 9: The system draws a contact relative motion (RM) vector line from the end of the ownship course and speed using the DRM for the direction and SRM for the distance. In one example, the vector line is drawn in a 5:1 scale to permit increased future visibility and prediction with respect to a contact. For example, t generation of the speed triangle shown in the center of the GUI display of FIG. 4 illustrates a contact course and speed that is visually verifiable by the user. FIG. 4 illustrates an exemplary display generated by the present invention upon completion of steps 7 through 9 and step 11.

Step 10: If the system determines that ownship has maneuvered, such as by conducting a course or speed change, or possibly both, the system repeats steps 1 and 2 to determine ownship's course and speed, and to generate an ownship speed vector. The invention then uses each contact's last two geographic positions, such as a based on a RADAR hit or other contact input data received by the system, to calculate each contact's course and speed over ground. Each contact's course and speed over ground are then used to calculate each contact's CPA and target angle. The user can still visually verify the DRM, MRM and SRM as well as determine that the displayed CPA makes sense.

Step 11: The contact's course, speed, CPA, bearing, range and time, as well as the calculated target angle are displayed. In one example, the system now generates and displays each contact's course and speed triangle.

Once the system has calculated at least one contact's course, speed and CPA the user may elect to maneuver to maintain navigational track, avoid contact or open contact distance, or close distance with contact. For example, in a “Trial Course and Speed” feature, the invention permits a user to selectively input one or more ownship course and speed changes, and the system then generates and visually displays the associated changes in CPA for any or all contacts in the active database. The feature takes into account the projected geographical position of contacts based upon their last known coarse and speed. This “Trial Course and Speed” feature ensures the key decision makers are well-informed of the consequences of any ownship maneuvering change prior to any turn of speed change. Additionally, this feature allows a user to instantly calculate the effect of any contemplated ownship maneuver in high density traffic areas in fractions of a second vice the numerous minutes that would be required to perform the calculations and plot the predicted results manually. Additionally, in contrast to devices that roughly calculate the effect an ownship maneuver would have in relation to one CPA for a contact, the present invention displays and calculates the solutions for multiple contacts simultaneously based upon real-time ownship course and speed relative to ownship. Moreover, the invention plots and displays the results for all active contacts at digital processing speed to allow real-time calculations of ownship and all contact positions, as well as forecasting of future positions at selected times. The present invention provides a graphically displayed solution that provides immediate situational awareness by illustrating the relative positions and CPA of all contacts of concern simultaneously. Additionally, the invention allows the user to assign priority to active contacts based upon subjective factors of concern to the user. For example, a contact having the smallest CPA, but which crosses a stern of the ship can be manually assigned a lower priority than another contact that has a greater CPA that crosses the bow of the ship. This is because a large ship can speed up more readily than it can slow down or stop. This prioritization feature is unique versus known navigational tools, and effectively merges the mariner's experience and judgment with the invention. Additionally, a user can change the status of a contact from active (i.e. being one of potential concern) to inactive, i.e. no longer of significant concern. For example, active contacts are maintained in both the active and historical databases, whereas inactive contacts are preserved only in the historical database. Preserving contact data in the historical database allows the invention to provide playback of contacts and reconstruction of events, allowing study of near-misses among ownship, and among tracked contacts. This historical feature is another unique feature that is unprecedented in current navigation tool. Additionally, the present invention's manual control and input capability allows not only the prioritizing of contacts, but the additional and tracking of contacts that may be missed by conventional contact identification sources, such as craft and creatures too small for consistent RADAR detection, but recognizable by handheld laser or other measuring devices once manually detected.

Another desirable feature is especially helpful involves the optional GUI display of the algorithms used by the invention for user review. Preferably, the data and algorithms and methods to calculate such navigational parameters as MRM, DRM, SRM, course, speed, and CPA are displayable in a graphic format familiar to all professional mariners for verification and validation.

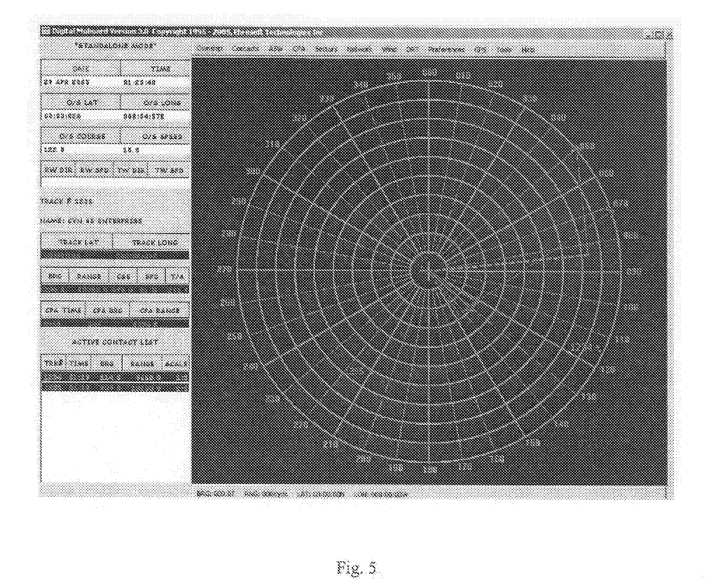

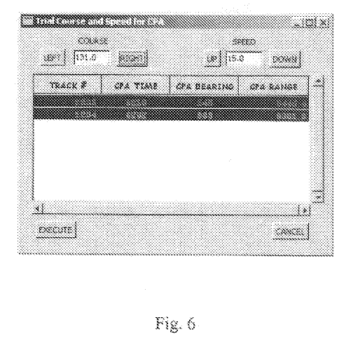

The digital processing speed of the invention allows for the user to dynamically adapt to the ever-changing traffic density and schemes of today's crowded seas, versus having to rely on human proficiency to make critical anti-collision decisions in close quarters. FIG. 5 illustrates an exemplary display of effect of CPA's by ownship maneuver to the right. FIG. 6 illustrates an exemplary window displaying each contacts' adjusted CPA for each ownship maneuver.

The present invention provides advantages for complicated formations involving fleets or convoys of ships, whether commercial or military. For example, Navy vessels may desire to steam in formation, or rendezvous with other ships for various reasons. This leads to a maneuvering requirement called a Change in Station, and involves a calculation that results in a recommended ownship course and speed to arrive at a relative or true position relative to another ship within a specified or non-specified time interval. As a collision avoidance tool, this feature allows a ship to safely drive to a predetermined designated point relative to another ship—thereby avoiding a collision or potential collision. In order to accomplish a change in station, the maneuvering ship must accurately determine the other ship's course and speed. The present invention accurately and quickly computes and displays required maneuvers for change of station situations. The recommended courses and speeds can then be used to determine the impact of such maneuvers in regards to the rest of known maritime traffic on a per contact basis.

To support fleet maneuvering requirements, ships are often given stationing sectors relative to a guide. Commonly, sectors are designated with an inner and outer range and starting and ending true or relative bearing from the guide. This invention incorporates the means to designate at least one guide ship and at least one sector for at least one ship in the formation.

The invention incorporates two information databases—a historical database that is an official record of all received and processed contacts, such as watchstander actions, and an active contact database for the storage, retrieval, processing and display of real-time or near real-time active contacts. Additionally, the system of the present invention facilitates rapid information exchange between workstations of the system, such as by a Local Area Network or Wide Area Network, whether wired or wireless, for instantaneous information sharing intraship and between ships and fleets, respectively. The present invention can thus provide for network-based information exchange, distribution, and display, and may permit the generation of real-time tabular and graphical reports that can be displayed or printed and held at the fingertips of key decision makers in fractions of seconds versus minutes.

In another example, the invention incorporates a user-configurable audio and visual CPA warning feature. The CPA feature permits Commanding Officers/Masters and key decision makers to be alerted early in the OODA Loop to any impending contacts of concern, providing the earliest possible advance notice of impending navigation problems. In one example, a microprocessor controlled workstation reads and runs computer executable code of the present invention execute the methods of the invention to receive and process ownship and contact information. The resulting displays and proposed maneuvering solutions, as previously described herein, supplement the Commanding Officer's ability to grasp the full relative motion and true motion picture early in the OODA Loop process. Where a ship driver or other decision maker arrives fresh to the ship's bridge, such as at a change of shift, the invention provides instant situational awareness by displaying all relevant ownship and contact data at a single GUI of the workstation. Additionally, the invention allows for tabbing between tabular versus graphical displays to permit a decision maker to review and/or validate information used by the invention and relevant to the OODA Loop process. The invention thus aid those decision makers newly arrived to the bridge or other monitoring location to have immediate situational awareness, and also to generate and contemplate various maneuvering options without losing valuable time in the Orientation Step.

As previously described, known maneuvering boards and methods are limited to a relative paper-based representation. The invention improves and enhances those systems and methods by integrating multiple features to overcome the paper-based maneuvering board limitations. One feature is incorporation of Global Positioning System inputs, which provides two benefits—ownship course and speed changes are automatically incorporated, meaning that relative motion between contacts and ownship is always up to date, and every contact hit results in the use of a GSA approved algorithm to calculate the contact's global position (Latitude and Longitude). In the event of an ownship maneuver between a contact's RADAR hits, the Invention calculates the contact's course, speed and Closest Point of Approach (CPA) based on GPS derived Course and Speed over ground calculations. Regardless of ownship's maneuvers, the invention always provides accurate and instant (real-time or near-real time) data, calculations, and solutions.

In another example, the invention further incorporates a Digital Dead Reckoning Tracer (DRT), which provides a true motion picture to key decision makers at all networked workstations, a feature that is only available to the U.S. Navy CIC watch team for paper-based systems. Display of a true display increases key decision makers' geographical Situational Awareness when considering ownship's maneuvering intentions—a feature that is unavailable on paper-based systems, while incorporation of digital charts and GPS in the DRT make the invention an all encompassing navigation and collision avoidance aid. Furthermore, ship operations are affected by to environmental conditions, and in the case of multi-purpose ships, activities such as the launch and recovery of aircraft are affected by wind. Indeed, landing on aircraft carriers can be quite precarious, and systems have been developed to assist in that process. It is imperative for such ships and operations that key decision makers are constantly able to make maneuvering decisions based on the relative and true direction and speed of wind. The invention calculates true wind direction and displays the solution in a user-verifiable GUI based on either manual or automatic input of relative and apparent wind direction and speed. For most associated flight operations, maritime vessels are required to achieve specific relative wind directions and speeds to ensure associated aircraft can safely take off and land on the vessels' decks. This invention calculates and generates at least one recommended ownship course and speed to achieve user inputted desired relative wind.

Often times, key decision makers need flexibility in flight operations and to ensure safe maneuvering while providing a safe launch and recovery deck they require the ability to calculate relative desired wind envelopes vice a specific desired wind and speed to safely launch and recovery aircraft with different wind limitations. This invention calculates desired relative wind envelopes based on user-selected inputs and displays them in both a user verifiable GUI and tabular format.

In one embodiment, the system of the invention incorporates at least one microprocessor with GUI as a workstation, with a preferred embodiment of two or more such workstations in communication with one another, as well as with portable microprocessor communication devices, preferably using wireless technology and standard networking protocols. More preferably, the preponderance of all such workstations are multi-purpose configurable. The following are exemplary minimum configurations for each workstation:

A. Networked—one workstation is designated as the Global Positioning System server and RADAR input point, although the RADAR and GPS servers do not have to be the same workstation. The primary data base is stored on this computer and replicated to all other networked computers. Upon failure of the primary server, any workstation can take over as the primary server proceed with contact management without any loss of data.

B. Standalone—a workstation can be used for automatic Global Positioning System input and RADAR input and not send the data over the network. In this configuration the workstation will ignore all network inputs and only save a locally generated data base.

C. Training—the workstation will provide step by step guidance to the user with the key goal of training the operator in the procedures for generating a maneuvering board solution.

D. Playback—the workstation will play back from the data base for reconstruction of an event. This is an excellent feature for playing back and discussing close maneuver situations after the fact to provide instant feedback to the watch team and discuss what-if scenarios.

Having thus described the invention in connection with a single embodiment thereof, it will be evident to those skilled in the art that various revisions and modifications can be made to the described embodiment without departing from the spirit and scope of the invention. It is my intention that all such revisions and modifications will be included within the scope of the following claims.

We claim:

1. A system for maritime contact management and collision avoidance, the system comprising:
at least one microprocessor;
a data storage facility accessible by the microprocessor to store, retrieve, and modify received data;
at least one graphic user interface associated with the microprocessor; and
computer-readable and executable instructions executable by the microprocessor for executing the steps of:
receiving data related to at least one ownship location, course and speed;
receiving initial contact data from at least one contact identification source;
receiving and processing additional ownship data relating to location, course, or speed;
receiving updated contact data from at least one contact identification source;
processing the received ownship data and contact data to calculate at least one of the at least one contact's course, speed, target angle, and closest point of approach relative to ownship; and
graphically displaying on the graphic user interface data comprising at least one of ownship's course and speed, relative motion between ownship and at least one contact, closest point of approach, and geopositional location.

2. The method of step 1, wherein the computer readable instructions executable by the microprocessor further comprise the step of:
generating at least one proposed maneuvering solution relating to the at least one ownship and the at least one contact.

3. The system of claim 6, wherein the computer readable instructions executable by the microprocessor further comprise the step of displaying the at least one proposed solution on the GUI.

4. The system of claim 3, wherein the recommended maneuvering course and speed are displayed on the GUI in tabular or graphical format.

5. The method of step 1, wherein the computer readable instructions executable by the microprocessor further comprise the steps of:
permitting a user to manually input new contact information and modify or delete existing contact information.

6. The system of claim 1, wherein the storage facility comprises at least an active database for housing data related to active contacts and ownship, and a historical database for housing previously received data.

7. The system of claim 1, wherein the computer executable code associates identifying information with each item of contact data received, and wherein the identifying information is selected form the group consisting of time of receipt, contact identifier; contact track number, contact name, contact identification, contact vessel type, contact vessel hull and pendant number, contact bearing, contact range from ownship, contact geopositional data, contact course, contact speed, contact target angle, and closest point of approach.

8. The system of claim 1, wherein the computer readable instructions executable by the microprocessor further comprise the step of receiving information comprising at least one of wind direction relative to ownship, wind speed relative to ownship, apparent wind direction to ownship, apparent wind speed to ownship.

9. The system of claim 8, wherein the computer readable instructions executable by the microprocessor further comprise the step of generating navigation solutions based on at least one of desired relative wind direction, desired relative wind speed.

10. The system of claim 9, wherein the at least one recommended maneuvering course and speed achieve a user-inputted desired relative wind envelope.

11. The system of clam 1, wherein ownship is a ship in a fleet formation, and wherein the at least one contact is another ship in the fleet formation.

12. The system of claim 11, wherein the computer executable code further comprises instructions for executing the steps of:
designating and graphically displaying at least one ship stationing sector comprised of a true or relative start bearing, end bearing, inner range and outer range relative to ownship.

13. The system of claim 1, further comprised of a communicable link to at least one other computer workstation to permit the other computer workstation to access information stored in the database.

14. The system of claim 13, wherein the computer-readable and executable instructions executable by the microprocessor include instructions for executing the step of broadcasting data across the communicable link for receipt by the at least one other computer workstation.

15. The system of claim 14, wherein the receiving workstation creates and stores the received data.

16. The system of claim 15, wherein the data comprises at least one of time-stamped contact track number, name, identification, ship type, ship hull and pendant number, bearing and range from ownship, geopositional data (in the form of latitude and longitude), course, speed, target angle, and closest point of approach data.

17. The system of claim 1, further comprising computer executable instructions for providing training of users in use of the invention using user-interactive windows displayed on the graphic user interface.

18. The system of claim 1, further comprising computer executable instructions for retrieving and displaying data from the historical database for the purpose of data extraction, reconstruction and playback of at least one ownship and at least one contact historical maneuvering scenario.
